(19) United States
(12) Patent Application Publication
(10) Pub. No.: US 2011/0066973 A1
(43) Pub. Date: Mar. 17, 2011

(54) Rendering System Log Data

(75) Inventors: Richard Plom, Clayton, CA (US); Ali Sazegari, Cupertino, CA (US)

(73) Assignee: APPLE INC., Cupertino, CA (US)

(21) Appl. No.: 12/558,422

(22) Filed: Sep. 11, 2009

(51) Int. Cl. G06F 3/048; G06F 9/54

(52) U.S. Cl. 715/808; 719/313

(57) ABSTRACT

Messages generated by processes on a computer system are aggregated into process groups. The process groups can be displayed in a single user interface using a number of graphs and plots to provide a holistic view of message activity for a given process group, and for all processes running on the computer system.

### TECHNICAL FIELD

This subject matter is related generally to system log data.

### BACKGROUND

Modern computer systems can have many processes running at the same time. Some of these processes generate system log data, which describe the health or status of the process. Conventional operating systems may include a simple message or log viewer that displays system log data as a flat list of messages. A flat list of messages, however, does not provide the user with a sense of trends or interaction between processes.

### SUMMARY

Messages generated by processes on a computer system can be aggregated into process groups. The process groups (e.g., applications, system, disk, network security) can be displayed in a single user interface using a number of graphs and plots to provide a holistic view of message activity for a given process group, and for all process groups running on the computer system.

In some implementations, messages for process groups can be displayed in a compound or grouped bar graph where each segment of the bar is associated with a different process group (hereafter “process group segment”), and each grouped bar graph can be associated with a message type (e.g., emergency, alert, critical, error, warning, notice, info, debug). The grouped bar graphs can indicate to a user message activity for each process group. The user can select (e.g., point and click) a process group segment of a grouped bar graph to get more detailed information about the messages generated by the process group. The detailed information can also be displayed as graphs to indicate a quantity of messages of a particular message type (e.g., horizontal bar graphs). A given grouped bar graph can be arranged as a side-by-side, joined or adjoining version; it may also have the bars partway on top of each other or overlapping. In some implementations, opposing or paired bars can be displayed. In some implementations, the process group segments of a grouped bar graph can be color coded with a color specified by the user.

In some implementations, a single user interface combines graphs (e.g., bar graphs, pie charts) and plots of process group messages with a message viewer for displaying messages. The messages displayed in the message viewer can be color coded to visually show the relationship between messages, message types and process groups. The user can “drill down” on a process group segment of a grouped bar graph (e.g., click or touch the segment) to view messages associated with the selected process group segment.

In some implementations, message activity from all process groups can be aggregated into a single, scrollable plot or curve to indicate total message activity on the computer system. The plot can include markers for indicating times where messages of a certain message type (e.g., alert messages) have occurred.

In some implementations, an interactive user interface element can be included in the user interface for filtering the display of messages by message type. Also, interactive user interface elements can be provided to allow a user to manage process groups and rules for filtering and displaying messages.

### BRIEF DESCRIPTION OF THE DRAWINGS

FIG. 1 is an example user interface for rendering system log data.

FIG. 2A is the example user interface of FIG. 1 with a process group segment selected.

FIG. 2B is another example user interface for rendering system log data with a process group segment selected.

FIG. 3A is an example user interface for managing process groups.

FIG. 3B is an example user interface for managing rules.

FIG. 4 is a flow diagram of an example process for rendering system log data.

FIG. 5 is a block diagram of an example architecture for rendering system log data.

### DETAILED DESCRIPTION

### System Overview

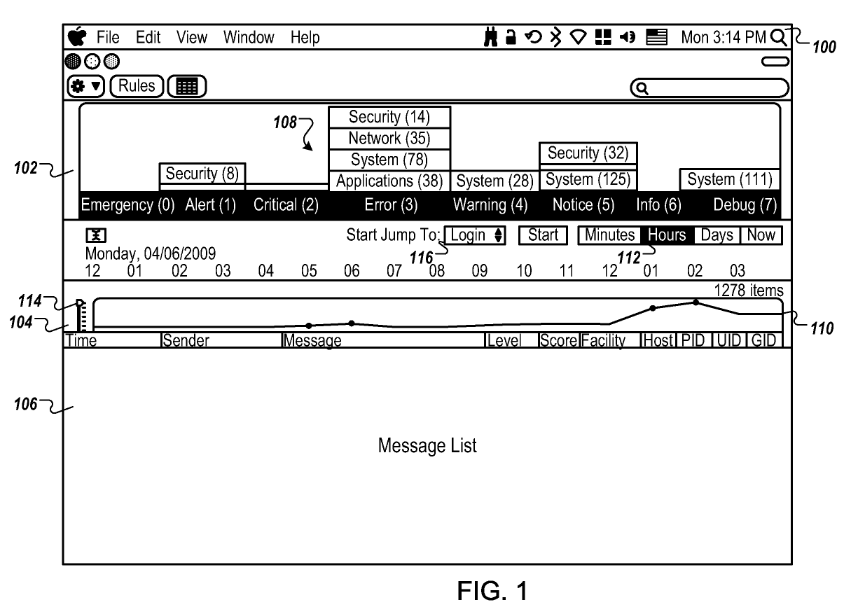

FIG. 1 is an example user interface 100 for rendering system log data. In some implementations, the user interface includes a first portion 102 for displaying grouped bar graphs 108, a second portion for displaying a plot 104 and a third portion 106 for displaying system log data. System log data can include any information that can be generated by a process or device of a computer system (e.g., error messages, alerts, notifications). The examples that follow refer to system log data as “messages” for convenience. A computer system can include but is not limited to: a personal computer (e.g., portable or desktop), work station, server computer, mobile device, game console, set top box, media player, or any other device or system capable of running processes that can generate messages.

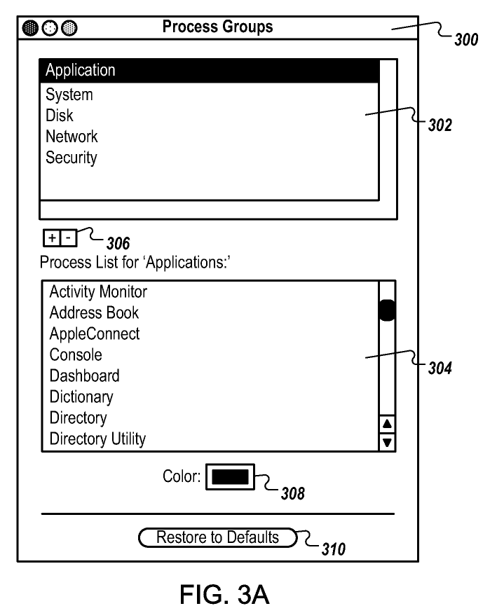

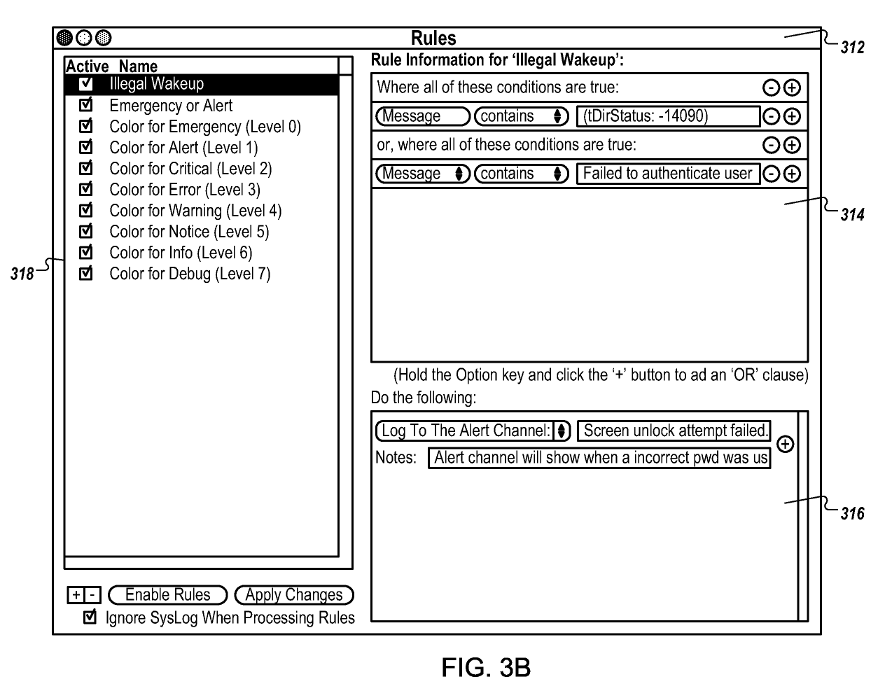

The grouped bar graphs 108 an include one or more process group segments. A process group is a logical group of processes running on a computer system. Some example process groups can include but are not limited to: Applications, System, Disk, Network and Security. The Applications process group includes processes spawned by applications running on the computer system, the System process group includes processes spawned by the operating system, the Disk process group includes processes related to hard disk activities on the computer system, the Network process group includes processes related to network connectivity and the Security process group includes processes related to security activities on the computer system. For example, as shown in FIG. 3 for an Apple Inc. computer with a Mac OS operating system, the Applications process group can include the following processes: Activity Monitor, Address Book, AppleConnect, Consol, Dashboard, Dictionary, Directory and Directory Utility. Other process groups are possible.

In some implementations, each process group segment can display a number of messages generated by the process group. In the example shown, the grouped bar graph 108 includes four process group segments which correspond to the process groups: Security (14) or 14 Security messages, Network (35) or 35 Network messages, System (78) or 78 System messages and Applications (38) or 38 Applications messages. Each grouped bar graph 108 in the first portion 102 can be labeled with a message type to indicate that only messages of the message type are represented by the group bar graph 108.

In the example shown, the grouped bar graphs 108 are associated with eight labels indicating eight different message types which, in this example, represent different severity levels. In this example, the message types are: Emergency, Alert, Critical, Error, Warning, Notice, Info and Debug. Other message types are also possible. As shown in FIG. 1, the grouped bar graph 108 is associated with message type “Error (3),” and includes four process group segments: Security (14), Network (35), System (78) and Applications (38). Each process group segment displays in parentheticals a number of Error messages for that process group. In this example the grouped bar graph 108 and its label “Error (3)” indicates all the process groups that have generated Error (3) messages, and the number of Error (3) messages generated by each of those process groups. The vertical height of a given process group segment can indicate the number of messages in that process group. In the grouped bar graph 108, the System process group generated the most Error (3) messages and, therefore, has more vertical height than the other process group segments in the grouped bar graph 108. A given grouped bar graph can be arranged as a side-by-side, joined or adjoining version; it may also have the bars partway on top of each other or overlapping. In some implementations, opposing or paired bars can be displayed.

Although grouped bar graphs were described, other graphs, charts, and tables, 2D or 3D, can be used to visually relate messages, message types and process groups. Some examples of graphs include but are not limited to: pie charts, mesh plots, line graphs and histograms.

In some implementations, a second portion 104 of user interface 100 includes a plot 110 of all message activity for all process groups over a specified time range. The time range can be specified by a user using one or more controls. For example, the user can interact with one or more controls 112 to specify a time range. In the example shown, the user can interact with controls 112 (e.g., buttons) to specify a start time and a time scale (e.g., minutes, hours, days, now) for the plot 110. In the example shown, the time scale is selected to be in hours and 1278 messages are included in the plot 110. The user can also scroll the plot 110 along the time axis by clicking and dragging the plot from left to right or vice versa. If the user interface 100 is a touch sensitive display, the user can use a “swiping” gesture from left to right or vice versa to move the time axis. In some implementations, a “Smart Jump” control 116 can be included to “jump” to a specified event (e.g., login event) to display message activity occurring during the specified event. In some implementations, a user can use a cursor or finger to delineate (e.g., highlight) a portion of the plot 110 for display, effectively zooming the plot 110 to a particular time or time range of interest indicated by the delineation. In some implementations, the plot 110 can include markers 118 that indicate message activity of a particular message type (e.g., Alert messages).

In some implementations, a filter control 114 (e.g., a slider) can be used to preclude messages of a particular message type from being included in the plot 110. For example, the filter control 114 can be manipulated by a user to only allow messages having a severity level 3 or higher to be included in the plot 110. The filter control 114 allows the user to quickly view only message activity for a particular message type (e.g. for a particular severity level), as indicated by the filter control 114 (e.g., the position of the slider). In the example shown, the slider is positioned at the top of its allowable range, specifying that “all” message activity for all message types over the specified time range are to be included in the plot 110.

In some implementations, the user interface 100 includes a third portion 106 of the user interface 100 for presenting a flat list of messages 106 (hereafter also referred to as a “message viewer”). In the example shown, each message or row in the list can include the following message metadata: Time, Sender, Message, Level, Score, Facility, Host, process identifier (PID), process user identifier (UID), and process group identifier (GID). Other message metadata can also displayed in the user interface 100 as desired. The messages can be scrolled using a navigation control (e.g., a slider) or gesturing if presented on a touch sensitive display or if the computer system includes a touch sensitive pad. The messages can be color-coded to identify the messages as belonging to a particular message type (e.g., red can indicate an Alert message) to allow the messages to be visually identified by a user as belonging to a particular message type. The markers 116 on plot 110 can be color coded to allow users to visually match message activity on plot 110 with messages displayed in the third portion 106 of the user interface.

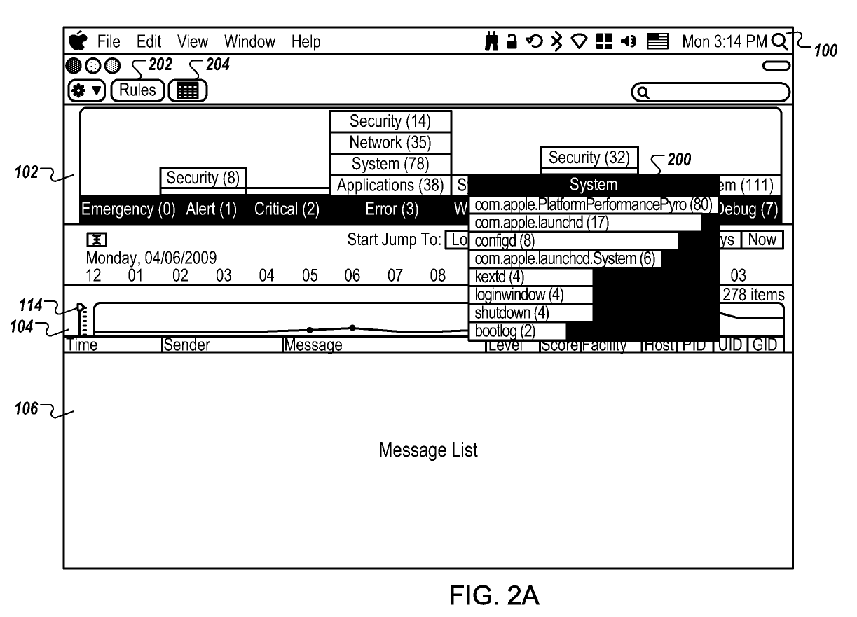

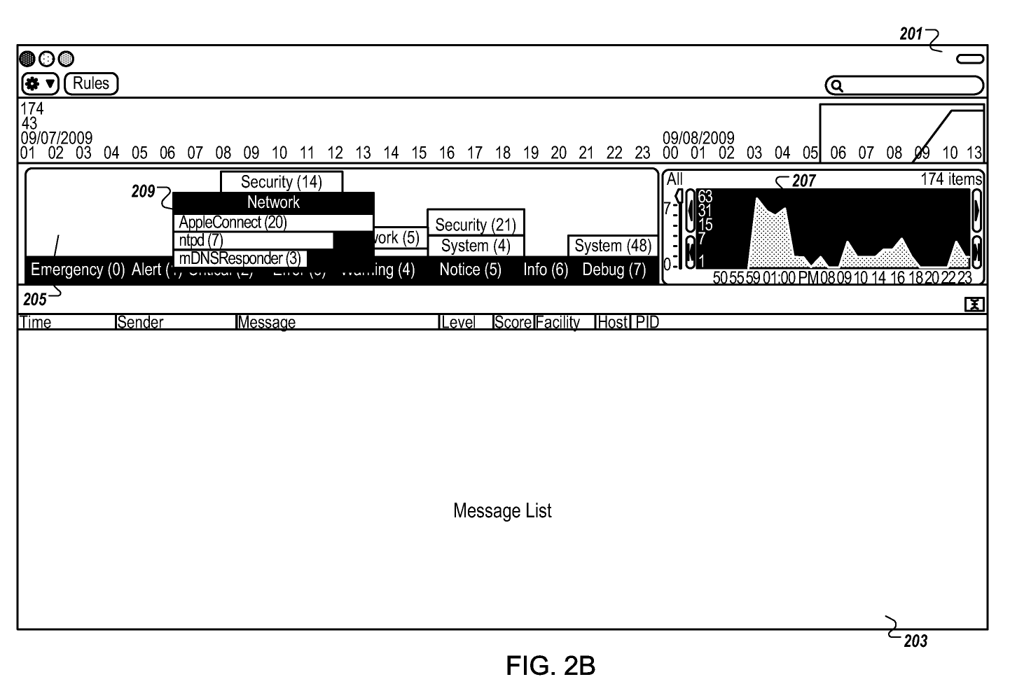

FIG. 2A is the example user interface of FIG. 1 with a process group segment selected. In the example shown, the System process group segment of grouped bar graph 108 was selected, resulting in pane 200 being presented in the user interface 100. The pane 200 can include further detail about messages in the System process group. In this example, horizontal bars for messages are shown where the length of the bars indicate a number of the same messages with the longest horizontal bar on top. Accordingly, a user can get a quick visual “snap shot” of the message types associated with the system process group. In this example, there were 80 messages with the description “com.apple.PlatformPerformance.Pyro,” and 2 messages with the description “bootlog,” as indicated by the longest and shortest bars, respectively. The horizontal bars can be color coded. In some implementations, a user can interact with button 202 or other user interface element to enter a rules dialog for specifying messages rules, as described in reference to FIG. 3B.

FIG. 2B is another example user interface 201 for rendering system log data with a process group segment selected. The user interface 201 can include a first portion 205 for displaying grouped bar graphs, a second portion 207 for displaying a plot and a third portion 203 for displaying system log data. In this example, a Network process group has been selected, resulting in pane 209 being displayed. The user interface 201 is functionally similar to the user interface 100 of FIG. 2A, except that the first portion 205 and the second portion 207 are displayed horizontally adjacent to each other, and the third portion 203 is displayed below the first and second portions 205, 207. In some implementations, the portions 203, 205, 207 are objects that a user can manually rearrange in the user interface 201 by clicking and dragging the objects and/or resizing the objects using handles or other controls, for example.

FIG. 3A is an example user interface 300 for managing process groups and assigning colors to process groups. The user interface 300 can be invoked in response to a user interacting with user interface element 204 (e.g., a button) shown in FIG. 2A.

In some implementations, the user interface 300 can include a first portion 302 for displaying process group names. Controls 306 can be used to enter a dialog for adding or deleting process groups. When a particular process group name is highlighted or otherwise selected in the first portion 302, a list of processes for the selected process group is displayed in a second portion 304 of the user interface 300. A color box 308 indicates the color for the selected process group. Colors can be changed by selecting an option from a pull down menu. A user interface element 310 (e.g., a button) can be selected to restore default process groups and colors.

FIG. 3B is an example user interface 312 for managing rules. In some implementations, the user interface 312 can include a first portion 318 for displaying rules and user interface elements for activating and deactivating the rules (e.g., using check boxes). A second portion 314 allows the user to specify conditions for the rule that is highlighted in the first portion 318. In the example shown, the rule “Illegal Wakeup” is highlighted in the first portion 318 and the user has specified two conditions for the “Illegal Wakeup” rule, which are related by a Boolean OR. The conditions can be read as follows: “if a message contains (tDirStatus: −14090), OR “if a message contains ‘Failed to authenticate user’”, then do the following action: “Log To The Alert Channel.” In this example, the user can hold down an option key and click the ‘+’ button to add an ‘OR’ clause. Once the conditions have been specified, the user can enable the rules by, for example, clicking or touching the Enable Rules button.

### Example Process

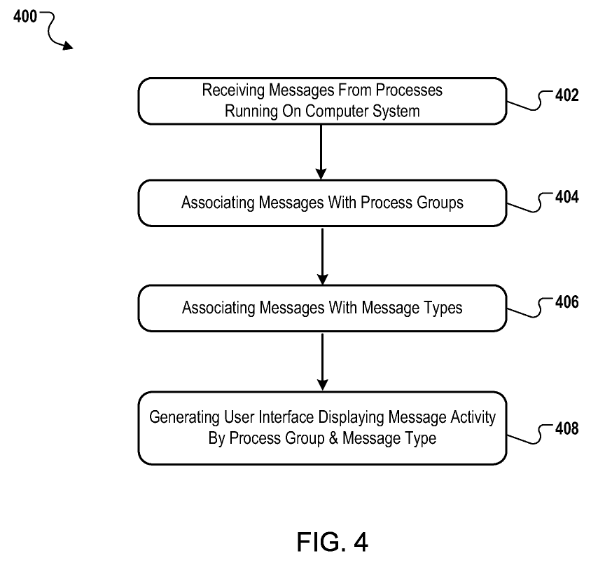

FIG. 4 is a flow diagram of an example process 400 for rendering system log data. The process 400 will be described in reference to a system for performing the process (e.g., a computer system).

In some implementations, the process 400 can begin when messages are received from one or more processes running on a computer system (402). The system associates the messages with one or more process groups (404). The associating can include tagging the messages with a process group ID and using the tags to index the messages in a database for later retrieval. In some implementations, the process groups can be specified by a user, as described in reference to FIG. 3A. The messages can also be associated with message types such as severity levels (406). A user interface is generated for displaying message activity by process group and message type (408). For example, the user interface can include a first portion for displaying grouped bar graphs having process group segments representing process groups. The process group segments can be color coded using colors specified by the user or default colors. The grouped bar graphs can be visually associated with message types. The grouped bar graphs can be labeled with a message type.

The user interface can include a second portion for displaying a plot of message activity for all process groups of the computer system. A filter control can be provided to limit the plot to certain message types. The plot can be scrolled and otherwise manipulated to focus on particular times of interest. Markers can be included on the plot to indicate messages of a particular message type. The markers can be color coded to visually indicate the message type.

The user interface can include a third portion for displaying a flat message list or message viewer. Messages in the list can be color coded to correspond to process group segments in grouped bar graphs or markers on the plot of message activity. Various controls can be included for manipulating the bar graphs and plots, filtering plot data and accessing more detailed information for messages and process groups by interacting with the bar graphs and plots. Various aspects of the user interface can be specified by a user using dialogs, including specifying process groups, color codes, and rules for managing messages.

### Example System Architecture

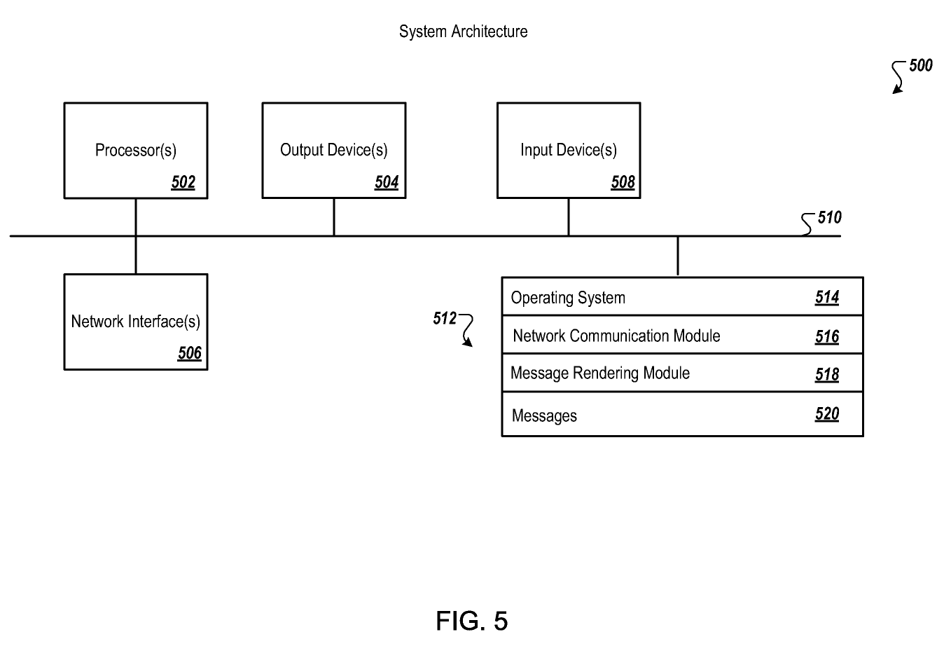

FIG. 5 is a block diagram of a system architecture 500 for implementing the features and operations described in reference to FIGS. 1-4. Other architectures are possible, including architectures with more or fewer components. In some implementations, the architecture 500 includes one or more processors 502 (e.g., dual-core Intel® Xeon® Processors), one or more output devices 504 (e.g., LCD), one or more network interfaces 506, one or more input devices 508 (e.g., mouse, keyboard, touch-sensitive display) and one or more computer-readable mediums 512 (e.g., RAM, ROM, SDRAM, hard disk, optical disk, flash memory, etc.). These components can exchange communications and data over one or more communication channels 510 (e.g., buses), which can utilize various hardware and software for facilitating the transfer of data and control signals between components.

The term “computer-readable medium” refers to any medium that participates in providing instructions to a processor 502 for execution, including without limitation, non-volatile media (e.g., optical or magnetic disks), volatile media (e.g., memory) and transmission media. Transmission media includes, without limitation, coaxial cables, copper wire and fiber optics.

The computer-readable medium 512 further includes an operating system 514 (e.g., Mac OS® server, Windows® NT server), a network communication module 516, message rendering module 518 for rendering messages 520 as described in reference to FIGS. 1-4. The operating system 514 can be multi-user, multiprocessing, multitasking, multithreading, real time, etc. The operating system 514 performs basic tasks, including but not limited to: recognizing input from and providing output to the devices 506, 508; keeping track and managing files and directories on computer-readable mediums 512 (e.g., memory or a storage device); controlling peripheral devices; and managing traffic on the one or more communication channels 510. The network communications module 516 includes various components for establishing and maintaining network connections (e.g., software for implementing communication protocols, such as TCP/IP, HTTP, etc.).

The architecture 500 can be implemented in a parallel processing or peer-to-peer infrastructure or on a single device with one or more processors. Software can include multiple software components or can be a single body of code.

The disclosed and other implementations and the functional operations described in this specification can be implemented in digital electronic circuitry, or in computer software, firmware, or hardware, including the structures disclosed in this specification and their structural equivalents, or in combinations of one or more of them. The disclosed and other implementations can be implemented as one or more computer program products, e.g., one or more modules of computer program instructions encoded on a computer readable medium for execution by, or to control the operation of, a data processing apparatus. The computer readable medium can be a machine-readable storage device, a machine-readable storage substrate, a memory device, a composition of matter effecting a machine-readable propagated signal, or a combination of one or more them. The term “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of one or more of them. A propagated signal is an artificially generated signal, e.g., a machine-generated electrical, optical, or electromagnetic signal, that is generated to encode information for transmission to a suitable receiver apparatus.

A computer program (also known as a program, software, software application, script, or code) can be written in any form of programming language, including compiled or interpreted languages, and it can be deployed in any form, including as a stand alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Computer readable media suitable for storing computer program instructions and data include all forms of non volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, the disclosed implementations can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

The disclosed implementations can be implemented in a computing system that includes a back end component, e.g., as a data server, or that includes a middleware component, e.g., an application server, or that includes a front end component, e.g., a client computer having a graphical user interface or a Web browser through which a user can interact with an implementation of what is disclosed here, or any combination of one or more such back end, middleware, or front end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client-server relationship to each other.

While this specification contains many specifics, these should not be construed as limitations on the scope of what being claims or of what may be claimed, but rather as descriptions of features specific to particular implementations. Certain features that are described in this specification in the context of separate implementations can also be implemented in combination in a single implementation. Conversely, various features that are described in the context of a single implementation can also be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understand as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products.

Particular implementations of the subject matter described in this specification have been described. Other implementations are within the scope of the following claims. For example, the actions recited in the claims can be performed in a different order and still achieve desirable results. As one example, the processes depicted in the accompanying figures do not necessarily require the particular order shown, or sequential order, to achieve desirable results. In certain implementations, multitasking and parallel processing may be advantageous.

What is claimed is:

1. A computer-implemented method, comprising:
receiving messages from processes running on a computer system;
associating messages with process groups;
associating messages with message types; and
generating a user interface for displaying message activity by process groups and message types.

2. The method of claim 1, where process groups are specified by a user.

3. The method of claim 1, where the user interface includes grouped bar graphs having one or more process group segments, each process group segment associated with a process group.

4. The method of claim 3, where each grouped bar graph is associated with a message type.

5. The method of claim 4, where the message type indicates a severity level.

6. The method of claim 3, further comprising:
receiving input selecting one or the process group segments; and
responsive to the selection, displaying message activity for the selected process group segment.

7. The method of claim 1, where the user interface includes a plot showing message activity for all process groups.

8. The method of claim 7, where the plot includes markers indicating a time of occurrence of messages of a specified message type.

9. The method of claim 7, comprising:
receiving input through a user interface element in the user interface, the input specifying a message type to be used as plot data.

10. The method of claim 1, where the user interface includes a message viewer for displaying messages and messages metadata, the messages being color coded to indicate a message type or a process group.

11. The method of claim 1, comprising:
receiving input through a user interface element in the user interface, the input specifying a process group.

12. The method of claim 1, comprising:
receiving input through a user interface element in the user interface, the input specifying a one or more rules for managing messages.

13. A computer-implemented method, comprising:
receiving messages from processes running on a computer system;
associating messages with process groups and message types;
selecting messages for display based on one or more rules; and
generating a user interface for displaying the selected messages by process groups or message types.

14. The method of claim 13, comprising:
receiving input through a user interface element in the user interface, the input specifying the one or more rules.

15. The method of claim 13, where generating a user interface comprises:
generating for first portion of the user interface for displaying one or more grouped bar graphs, each grouped bar graph having one or more process group segments;
generating a second portion of the user interface for displaying a plot message activity for two or more process groups; and
generating a third portion of the user interface for displaying a message view for displaying flat messages in a list with message metadata.

16. A computer-readable medium having instructions stored thereon, which, when executed by at least one processor, causes the at least one processor to perform operations comprising:
receiving messages from processes running on a computer system;
associating messages with process groups;
associating messages with message types; and
generating a user interface for displaying message activity by process groups and message types.

17. The computer-readable medium of claim 16, where process groups are specified by a user.

18. The computer-readable medium of claim 16, where the user interface includes grouped bar graphs having one or more process group segments, each process group segment associated with a process group.

19. The computer-readable medium of claim 18, where each grouped bar graph is associated with a message type.

20. A computer-readable medium having instructions stored thereon, which, when executed by at least one processor, causes the at least one processor to perform operations comprising:
receiving messages from processes running on a computer system;
associating messages with process groups and message types;
selecting messages for display based on one or more rules; and
generating a user interface for displaying the selected messages by process groups or message types.

21. The computer-readable medium of claim 20, comprising:
receiving input through a user interface element in the user interface, the input specifying the one or more rules.

22. The computer-readable medium of claim 20, where generating a user interface comprises:
generating for first portion of the user interface for displaying one or more grouped bar graphs, each grouped bar graph having one or more process group segments;
generating a second portion of the user interface for displaying a plot message activity for two or more process groups; and
generating a third portion of the user interface for displaying a message view for displaying flat messages in a list with message metadata.
